(19) United States
(12) Patent Application Publication
(10) Pub. No.: US 2015/0026360 A1
(43) Pub. Date: Jan. 22, 2015

(54) METHOD AND SYSTEM FOR SUPPORTING WIRELESS COMMUNICATIONS

(71) Applicant: GM GLOBAL TECHNOLOGY OPERATIONS LLC, DETROIT, MI (US)

(72) Inventor: Robert A. Hrabak, West Bloomfield, MI (US)

(73) Assignee: GM GLOBAL TECHNOLOGY OPERATIONS LLC, DETROIT, MI (US)

(21) Appl. No.: 13/947,396

(22) Filed: Jul. 22, 2013

(51) Int. Cl. H04W 80/04

(52) U.S. Cl. CPC H04W 80/04
USPC 709/232

(57) ABSTRACT

A system for communicating with a portable electronic device includes an electronic control module including operative logic when implemented. The electronic control module is in communication with the portable electronic device using a generic attribute profile (GATT). The system also includes a first portion of a GATT-based stack including logic for transforming GATT-based communications into a second communication protocol. The first portion of the GATT-based stack is configured for the electronic control module. The system also includes another electronic control module including operative logic when implemented. The other electronic control module is in communication with the electronic control module by the second communication protocol. The system further includes a second portion of the GATT-based stack including an application that communicates by a GATT-based profile. The second portion of the GATT-based stack is configured for the other electronic control module.

### FIELD OF THE INVENTION

Exemplary embodiments of the invention relate to wireless communications, and more particularly, to providing wireless communication support among devices having some variance in the type of communications protocols employed thereby.

### BACKGROUND

One type of wireless communications protocol for exchanging data over relatively short distances is the Bluetooth® protocol conforming to IEEE Standard 802.15. A low-power version of this short-range wireless communications protocol is the Bluetooth Smart® low energy (BLE) protocol, which has a power consumption of about 15 mA or less. In practice, devices that support more than one type of wireless communication protocol (e.g., Bluetooth and BLE) are often referred to as dual mode devices, while other devices that support only a single type of wireless communication protocol are referred to as single mode devices. In some applications, it would be desirable to be able to enable communications between devices that are otherwise communicatively incompatible, with respect to the communications protocols employed, by utilizing the functionality of a dual mode device.

### SUMMARY OF THE INVENTION

In one exemplary embodiment of the invention, a system for communicating with a portable electronic device is provided. The system includes an electronic control module including operative logic when implemented, the electronic control module in communication with the portable electronic device using a generic attribute profile (GATT). The system also includes a first portion of a GATT-based stack including logic for transforming GATT-based communications into a second communication protocol, the first portion of the GATT-based stack configured for the electronic control module. The system also includes another electronic control module including operative logic when implemented, the other electronic control module in communication with the electronic control module by the second communication protocol. The system further includes a second portion of the GATT-based stack including an application that communicates by a GATT-based profile, the second portion of the GATT-based stack configured for the other electronic control module.

In another exemplary embodiment of the invention, a method for communicating with a portable electronic device is provided. The method includes receiving generic attribute profile (GATT)-based communications, by an electronic control module, from the portable communications device. The portable electronic device uses a generic attribute profile (GATT). The method also includes transforming, via a first portion of a GATT-based stack, the GATT-based communications into a second communication protocol. The first portion of the GATT-based stack is configured for the electronic control module. Another electronic control module includes operative logic, when implemented, and is in communication with the electronic control module by the second communication protocol. A second portion of the GATT-based stack includes an application that communicates by a GATT-based profile. The second portion of the GATT-based stack is configured for the other electronic control module. The other electronic control module is in communication with the electronic control module by the second communication protocol.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a diagram of a system upon which wireless communication support may be implemented in an embodiment;

FIG. 2 is a diagram depicting an architecture of the system of FIG. 1 in an embodiment; and

FIG. 3 is a flow diagram describing a process for implementing wireless communication support in an embodiment.

### DESCRIPTION OF THE EMBODIMENTS

The following description is merely exemplary in nature and is not intended to limit the present disclosure, its application or uses. As used herein, the term module refers to an application specific integrated circuit (ASIC), an electronic circuit, a processor (shared, dedicated, or group) and memory that executes one or more software or firmware programs, or a combinational logic circuit.

An exemplary embodiment provides an approach for implementing wireless communication support to devices and, in particular, implementing generic attribute profile (GATT) based support to enable wireless communication. The GATT profile, which is part of the Bluetooth® Low Energy protocol (BLE), provides discovery and description services, such as defining how a set of attribute protocols are grouped to form a service.

The exemplary GATT based communication support may be implemented in a variety of applications. In one embodiment, the GATT based communication support is implemented for a vehicle. In this embodiment, the GATT based communication support enables a mobile electronic device (which is a dual mode device) to implement functions such as, for example, activating a module (a single mode device) of the vehicle to a key-on state through a host device (a dual mode device) in the vehicle. It will be understood that the GATT based communication support processes may be implemented in any environment in which a dual mode electronic device is seeking to communicate with a single mode device through another dual mode device.

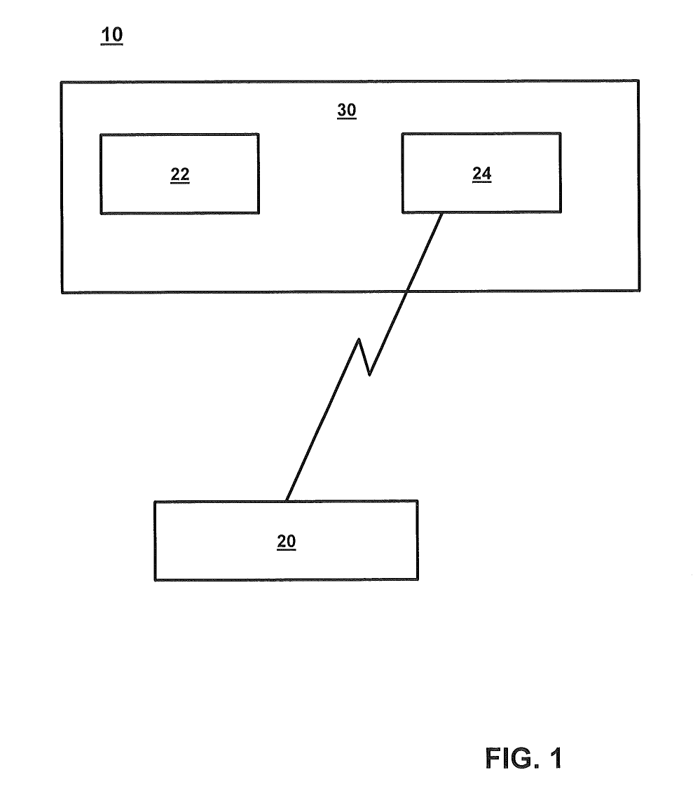

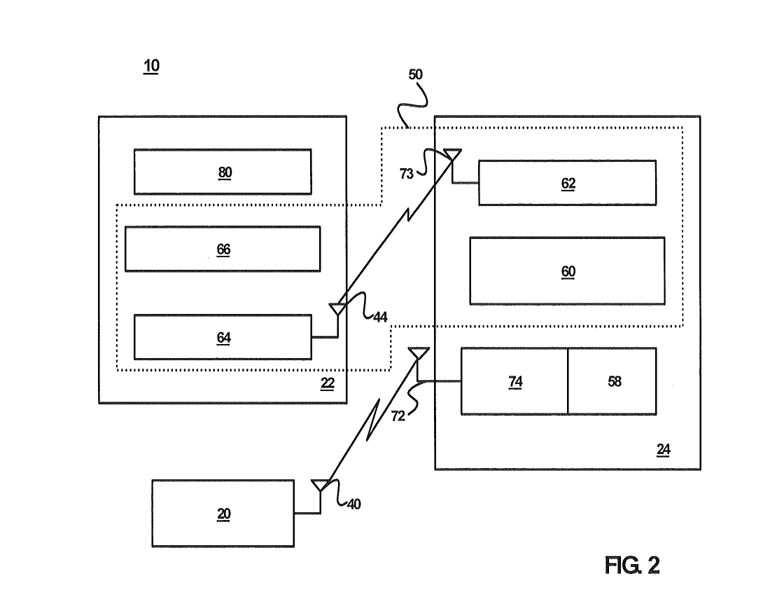

Referring now to FIGS. 1 and 2, a system 10 for implementing GATT based communication support is provided. The system 10 includes a portable electronic device 20, and a vehicle 30 of the system 10 may communicate with the portable electronic device 20 using a GATT protocol.

The vehicle 30 includes a first control module 22 and a second control module 24. In one approach, the first control module 22 may be a radio control module of the vehicle 30, and the second control module 24 may be a telematics control module (e.g., an OnStar® control module) of the vehicle 30.

The portable electronic device 20 may be any type of portable electronic device having a short-range wireless antenna 40 (shown in FIG. 2) sized to send and receive wireless communications based on the GATT protocol. Some examples of a wireless communications protocol based on the GATT protocol are the Bluetooth protocol conforming to IEEE Standard 802.15, and a low-energy version of the Bluetooth protocol that is referred to as the Bluetooth low energy (BLE) protocol. The BLE protocol generally has a power consumption of about 15 mA or less. The short-range wireless antenna 40 is in wireless communication with an antenna 72 (shown in FIG. 2) of the second control module 24.

In an embodiment, the second control module 24 is a dual mode device. This means that the second control module 24 includes logic, circuitry, or other interfaces needed to support both the wireless communications protocol (e.g., Bluetooth), as well as the low-energy version of the wireless communications protocol (e.g., BLE). In one embodiment, the portable electronic device 20 and the second control module 24 communicate with one another using the low-energy version of the wireless communications protocol (e.g., BLE) via respective antennae 40 and 72 (shown in FIG. 2).

In contrast, the first control module 22 may be a single mode device. This means that the first control module 22 includes logic, circuitry, or other interfaces needed to support only the wireless communications protocol (e.g., Bluetooth), but not the low-energy version of the wireless communications protocol. In the context of vehicle applications, an example of a single mode device is a radio control module, which typically does not have the ability to communicate with various wireless devices (e.g., a smartphone) using the BLE protocol, or any other low-power version of the short-range wireless communications protocol. Thus, the first control module 22 (e.g., the radio control module) may not be able to communicate directly with the portable electronic device 20 using the low-energy version of the wireless communications protocol. Instead, in an embodiment, the second control module 24 is used as a host to allow communication between the first control module 22 and the portable electronic device 20 using the low-energy version of the wireless communications protocol.

FIG. 2 provides detailed features of the first control module 22 and the second control module 24 for allowing the first control module 22 to interface with the portable electronic device 20. In an embodiment, the first control module 22 and the second control module 24 both share a single software stack 50 that is associated with the wireless communications protocol. For example, if the Bluetooth protocol is employed, the software stack 50 is a Bluetooth stack. The software stack 50 enables devices (e.g., the first control module 22, the second control module 24, and the portable electronic device 20) to locate one other and establish connectivity to exchange data and interact with one another through various applications.

The software stack 50 may include various protocols and profiles that are understood by those skilled in the art. For example, the Bluetooth stack 50 includes, for example, physical layers, an attribute protocol, a security manager, and various GATT services and profiles, none of which is shown in the Figure for ease of illustration. In an exemplary embodiment, the software stack 50 also includes components for implementing the exemplary GATT based communication support described herein. For example, the software stack 50 includes a wireless-to-GATT application 60, a GATT abstraction layer 66, and wireless clients 62 and 64.

A portion of the software stack 50 (e.g., the physical layers, the attribute protocol, the security manager, the wireless-to-GATT application 60, and the first wireless client 62) are located on the second control module 24. A remaining portion of the stack 50 (e.g., the wireless client 64, the GATT abstraction layer 66, the GATT services and GATT profiles) is located on the first control module 22.

The second control module 24 includes a wireless radio 74. The wireless radio 74 is in communication with the antenna 72 and includes the logic, circuitry, or other interfaces needed to enable communication with the portable electronic device 20 using the low-energy version of the wireless communications protocol (e.g., BLE). The physical layers of the software stack 50 process the data from the wireless radio 74, and may employ various standards, protocols, and devices, such as, for example, a baseband layer, a radio layer, logical link control and adaptation protocol (L2CAP), host-controller interface (HCI), and link layer (LL).

A generic attribute profile (GATT) 58 is used to interpret BLE signals from the portable electronic device 20, via the antennae 40 and 72. The software stack 50 then processes the signals as described herein.

The first control module 22 includes an embedded application 80. The application 80 may be any type of application that provides functions associated with the first control module 22. For example, the application 80 may be configured to perform vehicle ignition functions, such as a key-on state.

The first control module 22 communicates bi-directionally with the second control module 24 through RF antennae 44 and 73, respectively, in a wireless fashion. Alternatively, the first control module 22 and the second control module 24 may communicate through a wired connection. As shown in FIG. 2, the first control module 22 and the second control module 24 communicate through wireless client 62 that is resident on module 24 and wireless client 64 resident on module 22, through respective antennae. The wireless clients 62 and 64 may be configured as software modules capable of communicating with each other using wireless BT protocols.

The portable electronic device 20 may be any type of portable electronic device having a short-range wireless antenna 40 that is sized to send and receive short-range wireless communication associated with the GATT based protocol. The short-range wireless communication is used to exchange data over relatively short distances such as, for example, the Bluetooth protocol conforming to IEEE Standard 802.15. The short-range wireless antenna 40 is in communication with the second control module 24, where the second control module 24 includes transceiver circuitry for communication with the short-range wireless antenna 40.

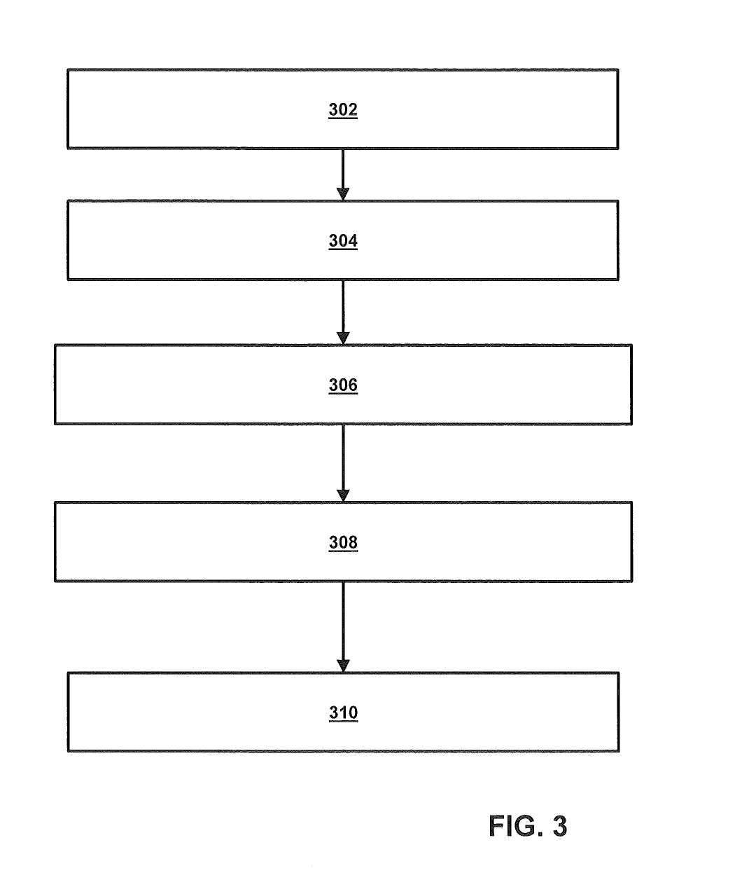

When the portable electronic device 20 initiates a communication with the vehicle 30 (e.g., to remotely start the vehicle), the portable electronic device 20 transmits a wireless BLE signal, which is received by the antenna 72 of the second control module 24. The portion of the software stack 50 for the second control module 24 processes the signal. In an embodiment, the wireless signal is converted to a GATT-based signal, as will be described further in FIG. 3.

The wireless client 62 then sends the processed/converted signal (GATT-based signal) to the wireless client 64 of the first control module 22 via respective antennae 73 and 44 using BT communication protocols. The GATT abstraction layer 66 processes the signal to determine an associated GATT service. The embedded application 80 implements the function (e.g., remote vehicle start) required by the signal.

In a reverse fashion, the single mode device 22 can communicate with the portable electronic device 20 via the dual mode device 24.

Thus, as indicated above, the shared software stack 50 enables a single mode device to constructively function as a dual mode device with respect to various vehicle functions.

Turning now to FIG. 3, a process for implementing the wireless communications support between the vehicle 30 and the portable electronic device 20 will now be described in an embodiment. The process of FIG. 3 assumes that a software stack 50 is shared among the first and second control modules 22 and 24, respectively, of the vehicle 30 and that the first control module 22 is configured as a single mode device.

At step 302, the second control module 24 receives a signal from the portable electronic device 20 to perform a vehicle function. The signal is transmitted as a BLE signal between antennae 40 and 72. The wireless radio 74 receives the signal and interprets the signal through the GATT 58. At step 304, the software stack 50 on the second control module 24 processes the signal. This processing may include converting the signal to a GATT-based signal. The converting may be implemented using various techniques. For example, in one embodiment, the wireless-to-GATT application 60 converts the signal into a payload of a Wi Fi message (e.g., wrapping BT GATT protocol into Wi Fi). In an alternative embodiment, the wireless-to-GATT application 60 extracts the GATT payload from the signal and passes the payload to a Wi Fi IP packet.

At step 306, the processed signal is sent from the second electronic control module 24 to the first control module 22. The signal may be delivered through corresponding wireless clients 62 and 64 and respective antennae 73 and 44. At step 308, the first control module 22 converts the processed signal. For example, the GATT abstraction layer 66 receives the GATT message within an IP packet and extracts the GATT message from the packet. Alternatively, the GATT abstraction layer 66 receives the Wi Fi IP packet and extracts the GATT payload from the Wi Fi IP packet. In either alternative, the message is then forwarded to the embedded application 80. At step 310, the first electronic control module 22, through the embedded application 80, implements the function specified by the signal and/or updates information pursuant to the signal.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system for communicating with a portable electronic device, the system comprising:
an electronic control module including operative logic when implemented, the electronic control module in communication with the portable electronic device using a generic attribute profile (GATT);
a first portion of a GATT-based stack including logic for transforming GATT-based communications into a second communication protocol, the first portion of the GATT-based stack configured for the electronic control module;
another electronic control module including operative logic when implemented, the other electronic control module in communication with the electronic control module by the second communication protocol; and
a second portion of the GATT-based stack including an application that communicates by a GATT-based profile, the second portion of the GATT-based stack configured for the other electronic control module.

2. The system of claim 1, wherein the electronic control module and the other electronic control module are embedded in a vehicle.

3. The system of claim 2, wherein the electronic control module is a telematics device.

4. The system of claim 2, wherein the other electronic control module is a radio control module.

5. The system of claim 1, wherein the GATT is implemented using Bluetooth Low Energy protocol.

6. The system of claim 1, wherein the second communication protocol includes Bluetooth protocol.

7. The system of claim 1, wherein the GATT-based communications are transformed into the second communication protocol by converting the GATT-based communications into a payload of a Wi Fi message.

8. The system of claim 7, wherein the application of the second portion of the GATT-based profile receives the Wi Fi message and extracts the payload from the Wi Fi message.

9. The system of claim 1, wherein the GATT-based communications are transformed into the second communication protocol by extracting a GATT payload from the GATT-based communications and pass the payload to a Wi Fi IP packet.

10. The system of claim 9, wherein the application of the second portion of the GATT-based profile receives the Wi Fi IP packet and extracts the GATT payload from the Wi Fi IP packet.

11. The system of claim 1, further comprising an application embedded in the other electronic control module, the application configured to implement a function associated with the GATT-based communications.

12. A method for communicating with a portable electronic device, comprising:
receiving generic attribute profile (GATT)-based communications, by an electronic control module, from the portable electronic device, the portable electronic device using a generic attribute profile (GATT);
transforming, via a first portion of a GATT-based stack, the GATT-based communications into a second communication protocol, the first portion of the GATT-based stack configured for the electronic control module;
wherein another electronic control module includes operative logic when implemented, the other electronic control module in communication with the electronic control module by the second communication protocol; and
wherein a second portion of the GATT-based stack includes an application that communicates by a GATT-based profile, the second portion of the GATT-based stack configured for the other electronic control module.

13. The method of claim 12, wherein the electronic control module and the other electronic control module are embedded in a vehicle.

14. The method of claim 13, wherein the electronic control module is a telematics device.

15. The method of claim 13, wherein the other electronic control module is a radio control module.

16. The method of claim 12, wherein the GATT is implemented using Bluetooth Low Energy protocol.

17. The method of claim 12, wherein the second communication protocol includes Bluetooth protocol.

18. The method of claim 12, wherein the GATT-based communications are transformed into the second communication protocol by converting the GATT-based communications into a payload of a Wi Fi message.

19. The method of claim 18, wherein the application of the second portion of the GATT-based profile receives the Wi Fi message and extracts the payload from the Wi Fi message.

20. The method of claim 12, wherein the GATT-based communications are transformed into the second communication protocol by extracting a GATT payload from the GATT-based communications and pass the payload to a Wi Fi IP packet.
